(19) United States
(12) Patent Application Publication
(10) Pub. No.: US 2016/0379194 A1
(43) Pub. Date: Dec. 29, 2016

(54) Platform For Progressive On-Line Group Purchasing

(71) Applicant: JOINTV NETWORK LTD., Tel Aviv (IL)

(72) Inventors: Eran Dvir, Tel Aviv (IL); Eran Fine, Tel Aviv (IL)

(21) Appl. No.: 15/039,997

(22) PCT Filed: Nov. 11, 2014
(86) PCT No.: PCT/IB2014/065948

§ 371 Date: May 27, 2016

Related U.S. Application Data
(60) Provisional application No. 61/909,384, filed on Nov. 27, 2013.

(51) Int. Cl. G06Q 20/12; G06Q 20/40; G06Q 30/06; G06Q 50/00; G06Q 20/10

(52) U.S. Cl. CPC G06Q 20/12; G06Q 50/01; G06Q 20/10; G06Q 30/0611; G06Q 20/4014

(57) ABSTRACT

This invention relates to a method of providing progressive on-line group purchasing of goods and services including the steps of selecting articles to be purchased, receiving a target group size and price, creating a group of target size from among friends in at least one social network, communicating separate purchasing and payment information to a retailer's server, and receiving from said retailer's server separate proofs of purchase for each one of the group members.

### CROSS-REFERENCE TO RELATED PATENT APPLICATIONS

This patent application claims priority from and is related to U.S. Provisional Patent Application Ser. No. 61/909,384, filed Nov. 27, 2013, this U.S. Provisional Patent Application incorporated by reference in its entirety herein.

### TECHNOLOGY FIELD

The present invention pertains to on-line purchase of goods and services and particularly to progressive group purchasing mechanisms of such goods.

### BACKGROUND

Individuals use the Internet to purchase products online primarily through e-commerce sites. An individual purchases and pays for the selected goods or services, typically using a shopping cart of the selling website. The e-commerce site collects the individual's information, comprised of the individual's payment and shipping information. Once the payment information is validated and the transaction processed, the shipping information is used to actually send the product or deliver the services.

Existing systems target the individual user who is identified by the retailer. The purchaser must be familiar with the retailer and aware of the goods available by him. This constraint imposes significant marketing and advertising expenses on the retailers (Customer Acquisition Cost).

Furthermore, existing billing systems are not flexible enough to allow for a billing plan having real-time changeable pricing schemes capable of supporting progressive marketing campaigns based on the “Friend brings Friend” concept via social networks and/or other peer-to-peer communication options such as IM (instant messaging) applications and email.

An additional shortcoming pertaining mainly to on-line content providers (such as digital TV and IPTV operators) is their inability to sell and provide individual content items (e.g. a specific series) to occasional customers. The CRM systems, billing systems and content fulfillment systems do not support this type of customers, which forces the providers to enlist them as full customers, entailing considerable customer acquisition costs, or forsake the sale.

Various domains enable the option of group purchase. Internet sites such as Groupon (http://www.groupon.com) and others enable a customer to join groups pre-formed by the website to purchase a product at a predefined reduced price. Other websites such as The Gifts Project (http://www.giftsproject.com/) enable convenient group purchasing without price reduction.

There does not exist a system for progressive on-line group purchasing of goods.

### SUMMARY

According to an aspect of the present invention there is provided a system for providing progressive on-line group purchasing of goods, comprising: at least one application server communicating over the internet with a plurality of electronic user devices and communicating with at least one retailer's server; at least one back-end server communicating with the at least one application server; each user of said electronic user devices is a member of at least one social network; each one of said electronic user devices running a client application communicating with the at least one application server; the application server comprising: a delivery management module configured to communicate with the retailers' server to enable goods or service selection; interface to at least one social network; a group formation and tracking module; interface to the at least one retailer's back-office systems; and a purchasing and payment engine configured to communicate separate purchasing and payment information to said at least one's server; and receive from said at least one retailer's server separate proofs of purchase for each one of said group members.

The client application may be configured to select goods or services and create a group from among friends in said at least one social network.

The client application may also be configured to select a group type.

Group type can be one of the following:
Fixed size group, a group of predetermined maximal size wherein said group size determines the price of said digital content goods or services.
Dynamic size group, a group of predetermined minimal size wherein said minimal group size determines the initial price of said goods or services.

The at least one application server may comprise a plurality of application servers, and the system may further comprise a load balancer configured to divide the load from said plurality of electronic user devices between said at plurality of application servers.

The purchasing and payment engine may comprise a flexible pricing process configured to: provide an initial price and a target group size for said selected goods or services; and update said initial price as a result of changes in said group size.

According to another aspect of the present invention there is provided a method of providing progressive on-line group purchasing of goods and services, comprising: selecting goods and services to be purchased; receiving a target group size and price; creating a group from among friends in at least one social network; communicating separate purchasing and payment information to a retailer's server; and receiving from said retailer's server separate proofs of purchase for each one of said group members.

The method may further comprise, during said step of creating, updating the price according to a current number of group members.

The method may further comprise: checking by said retailer's server whether a received purchasing information is for a registered user; and creating an account for said user if he is not registered.

### BRIEF DESCRIPTION OF THE DRAWINGS

For better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a schematic general block diagram of the system according to the present invention;

FIG. 2 is a schematic block diagram of the application server;

FIG. 3 is a schematic diagram of the flexible pricing process;

FIG. 4 is a schematic diagram of the system's interface with social networks and the interaction involving the social networks;

FIG. 5 is a schematic diagram of the group purchasing and payment engine;

FIG. 6 is a flowchart showing the processing done at the retailer's billing system upon invitation acceptance by a user; and

FIG. 7 is a flowchart showing the processing done at the group formation and payment tracking module upon the completion of a group formation.

### DETAILED DESCRIPTION OF EMBODIMENTS

The present invention provides a system and method that effectively extends the boundaries of the retailer's network, to include servicing individual occasional customers. The system provides the technology and service that enable existing billing and fulfillment systems to handle groups and to communicate with social networks transparently and seamlessly, with no change to the retailer's back office systems.

The system enables on-line group purchasing of goods and services. End users are provided with means to establish and manage, via social networks, groups of friends who wish to purchase goods and services as a group.

The system additionally offers the retailers the technology to bill the group members for the articles they are purchasing and payment tracking means (proof of purchase) for each group member during fulfillment.

The system uses a dynamic pricing model that calculates the final purchasing price as a function of the group size.

The system may be adapted to any type of online purchase of goods and services.

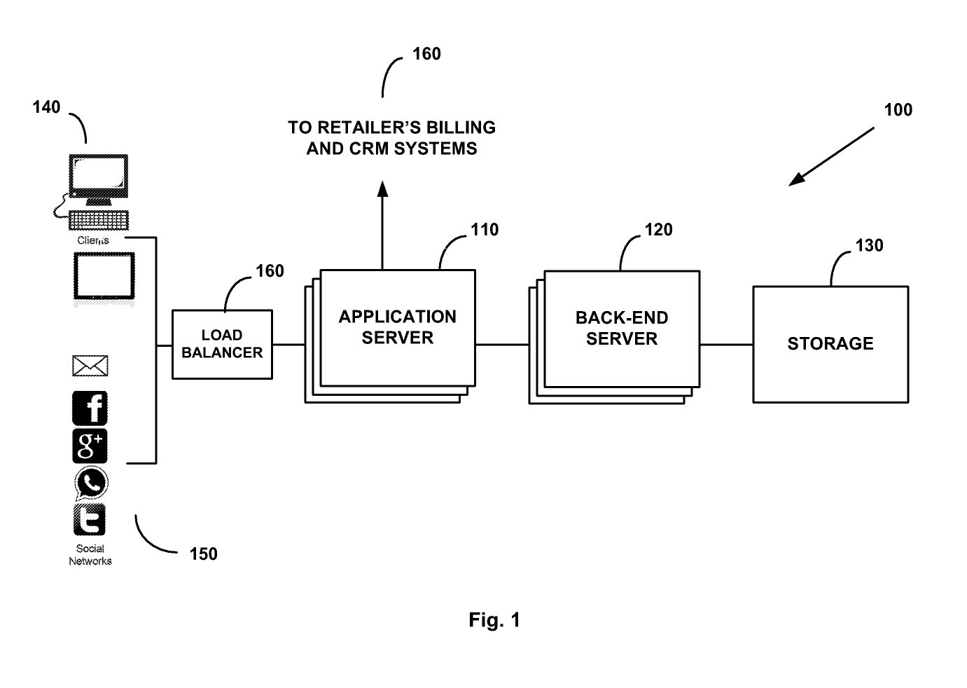

FIG. 1 is a schematic general block diagram of the system 100 according to the present invention. System 100 comprises one or more front-end application servers 110, which manage the business logic and the products catalog, one or more back-end servers 120 communicating with the front-end servers and with storage facilities 130 and a load balancer 160 for distributing the traffic between the application servers 110.

The application servers 110 supply information to the system clients, manage and perform processes, manage the progressive pricing according to the retailer's rules and definitions and bridge between client applications 140 running on client devices and retailers' billing and fulfillment systems 160. The application servers 110 also communicate with social networks, Instant Messaging and Email applications 150.

The client applications include a thin client, which enables using various devices for communicating with the system, such as desktop computers, laptop computers, smart phones, tablet PCs, PDAs, etc..

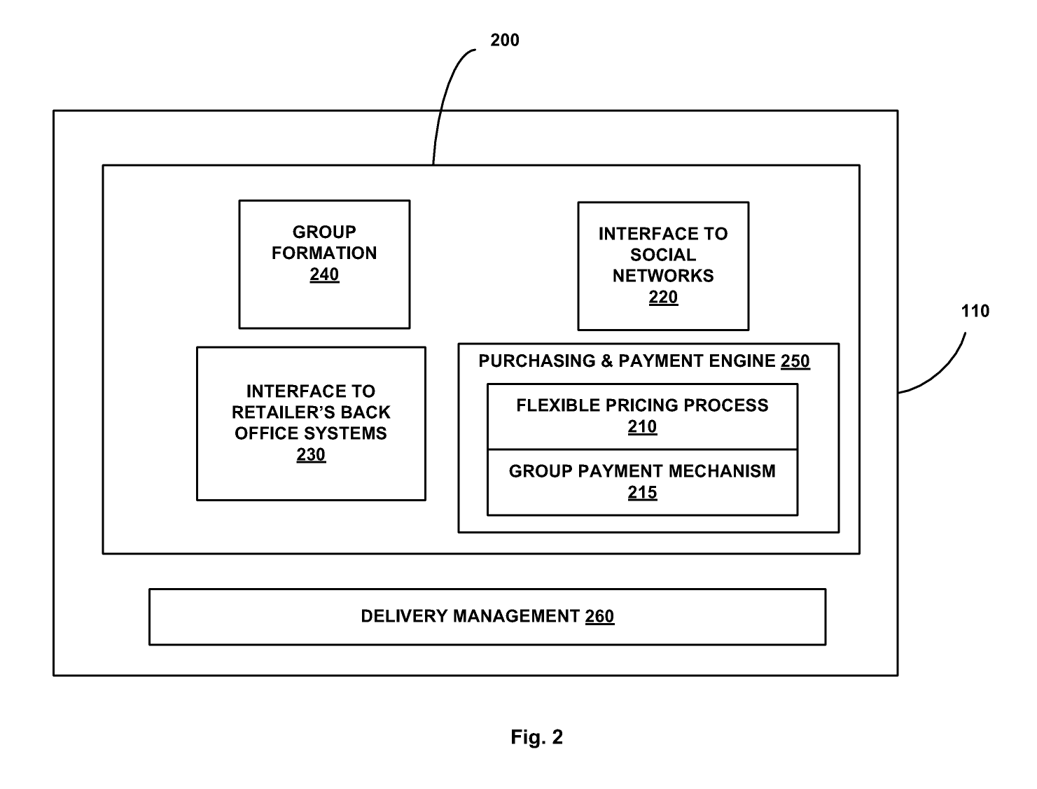

FIG. 2 is a schematic block diagram of the front-end application server 110, hosting the progressive group purchasing engine 200, which is the system's core and in charge of managing the purchasing groups and synchronizing their members. Engine 200 includes a number of services such as a purchasing & payment engine 250, comprising flexible pricing process 210 and group payment mechanism 215, interface to social networks 220, interface to back office systems (e.g. billing, fulfillment) of the retailers 230, group formation and tracking module 240. Front-end application server 110 also comprises a delivery management module 260 which communicates with the retailers' systems to enable article selection.

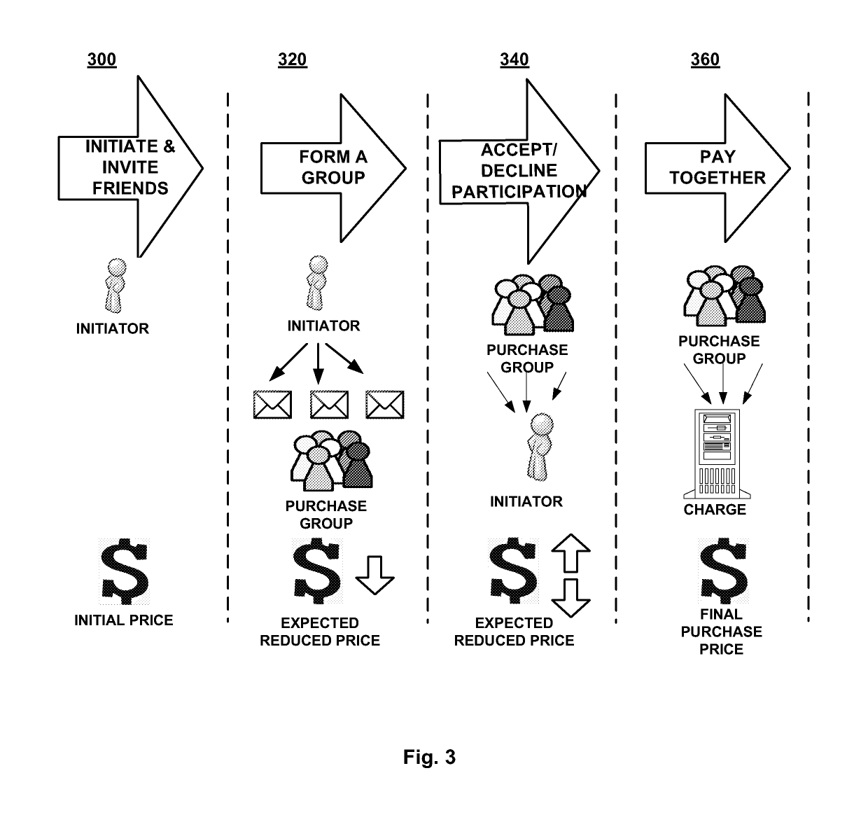

FIG. 3 is a schematic diagram of the flexible pricing process 210. An end user (initiator) who finds goods or services he is interested in purchasing (e.g. in the retailer's website or app or Facebook page) is presented with the possibility to form a purchasing group with friends and receive a reduced price (step 300). In order to receive the reduction the initiator has to form a group. The service enables this by connectivity to the initiator's social networks. The initiator may be presented with lists of friends from his social networks such as Facebook, twitter, Email and Google+. The initiator selects friends from these lists and sends them invitations to participate in his group (step 320). Alternatively, the initiator may “select all” friends to send them invitations.

If the initiator had formed groups in the past via the system, friends who participated in those groups may be displayed first. The system may suggest a default editable invitation style. The invitation may include a description of the article, links to additional online materials (sales promotion, pictures, reviews etc.) and the expected group price. The system may additionally publish a post on behalf of the initiator in the relevant social networks, stating his wish to purchase the article in a group purchase and enabling additional friends who have not been explicitly invited to express their wish to participate in the group, by pressing a link in the post. The initiator may approve or disapprove these participants.

A target group size may be predefined by the retailer along with a reduction (or a target price) to be awarded to each member of a target-sized group.

The initiator and any group member may launch the client application at any time and watch an updated status of the group.

The initiator may send invitations to a number of friends that exceeds the target group size (i.e. over-subscription) to increase the probability of the purchase taking place even if some friends reject the invitation. If the number of actual subscribers is greater than the target group size, the system may automatically offer to form a new group for the latecomers, to which they may invite their friend.

The limit imposed on the group size is intended for creating intimate groups—instead of big groups that may emphasize the reduced price and thus cause disrespect to the brand, an intimate group emphasizes the social aspect, increases the probability of favorable responses and does not offend the brand.

The client application may also be configured to select a group type.

A Group type can be, for example, one of the following:
Fixed size group, a group of predetermined maximal size wherein said group size determines the price of said goods or services.
Dynamic size group, a group of predetermined minimal size wherein said minimal group size determines the initial price of said goods or services.

People who were late to respond to the invitation are offered the opportunity to form a group of their own and invite additional friends. This achieves two goals:
1. Preventing disappointment.
2. Greater exposure (ripple effect).

Alternatively, the system may, at the retailer's discretion, allow latecomers to join the group at the maximum reduced price.

The system uses a flexible Consumer to Consumer (C2C) pricing model, which calculates the final price for each group member as a function of the group size. The dynamic pricing process tracks the group formation in real time and updates the price according to the number of members who have validated their participation. If a group member decides to leave before the actual purchasing, the price is incremented until a new member joins (step 340). This process enables the group members to conduct a direct price determination process without system intervention, until they arrive at a desired group size and price. All the while the system tracks the group members and the group price.

In step 360, after the final group purchasing price has been determined, each group member is charged for the purchase and the purchased article is delivered to each group member separately.

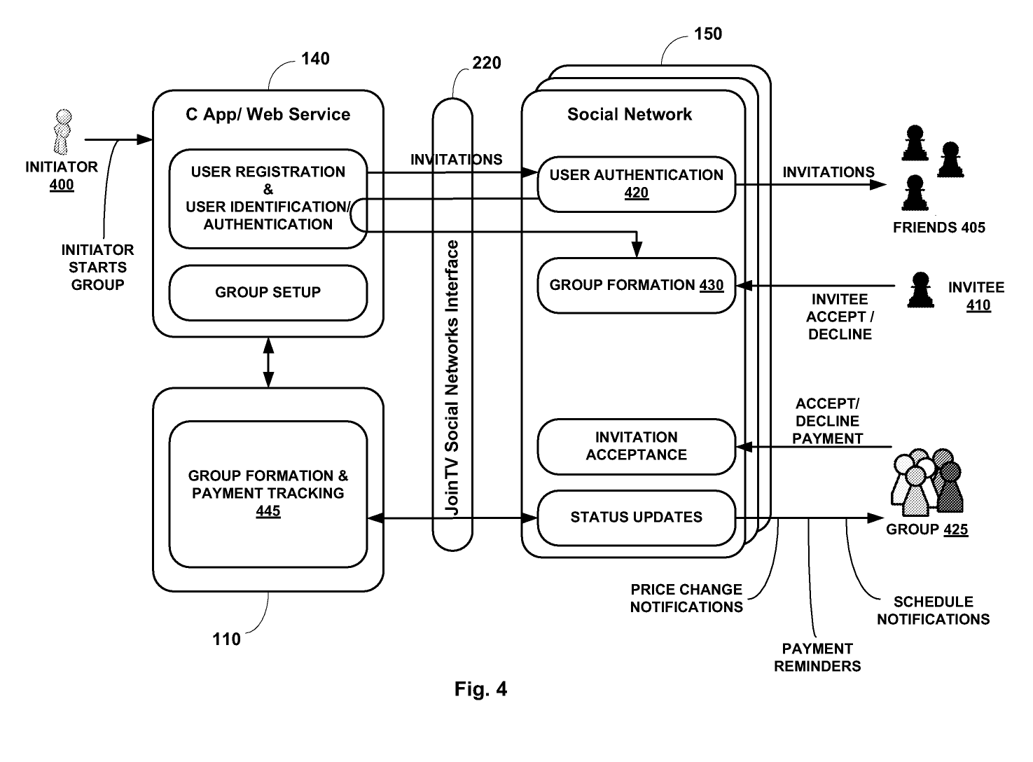

FIG. 4 is a schematic diagram of the system's interface with social networks and the interaction involving the social networks.

In a preliminary step the initiator 400 registers to the service using the client application or web service 140 (“Capp”).

When the initiator 400 wishes to start a group, the Capp communicates with his one or more social networks 150 via the system's social networks interface 220. Once the social network has authenticated 420 the user 400, the Capp presents him with a list of friends 405 from the social network, from which he may select friends to invite for participation in the group purchase. The Capp sends invitations to the friends selected by the initiator, including an expected reduced price for a group of the target size.

According to embodiments of the invention, the Capp may additionally or alternatively extract “friends” lists from other peer-to-peer communication applications residing on the user's computer, such as any IM application or email application.

Invitees 410 may accept or decline the invitation, thereby potentially affecting the group 425 price, which is continuously visible to the invitees and to the initiator.

The process terminates when the group stabilizes at the target size. Alternatively, if the target group size is not reached, the initiator may determine to proceed with a smaller group.

Each group member now receives a payment request. When all payments have been done, the purchased article is delivered to each group member separately.

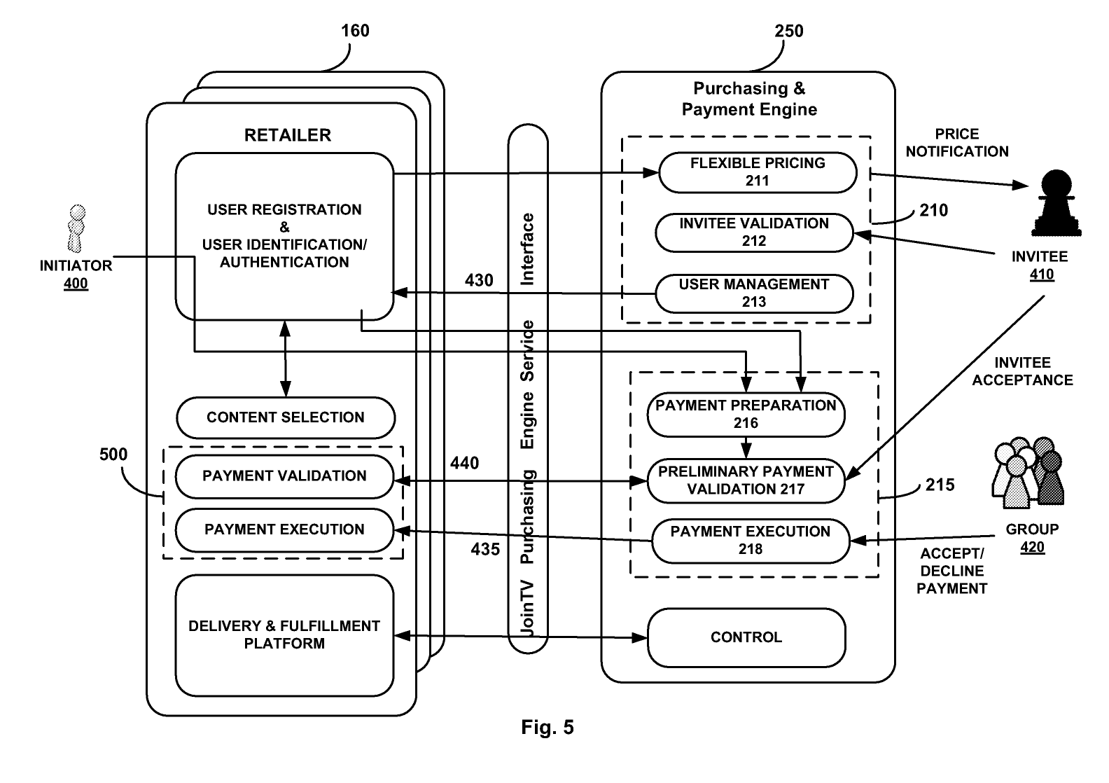

FIG. 5 is a schematic diagram of the group purchasing and payment engine 250 which comprises the progressive flexible pricing model 210 and the group payment mechanism 215. Since the retailer's billing and CRM are not designed to handle groups and group related pricing schemes, the group payment service abstracts the group, which is managed by the group purchasing engine, and presents its members as single customers to these back office systems. This enables the continued use of legacy systems without special retrofitting. The service additionally maps between the user's virtual identities (e.g. in different social networks) and the user's identification at the service provider's.

The flexible pricing model 210 comprises:
A flexible pricing module 211, which receives group updates and communicates updated group prices to invitees;
An invitee validation module 212, which validates the invitee's identity, checks whether the user has already accepted the invitation and whether there are still available seats in the group. If all checks complete successfully, the user is added to the group. Otherwise, the user is notified his invitation has been voided and the reason for that.
A user management module 213, which maps between a retailer's subscriber ID and a system and social networks user. Enables retailers to recruit new customers based on the group members, to support users and to track users' purchasing history as a group and as individuals, in order to provide them with the best service.

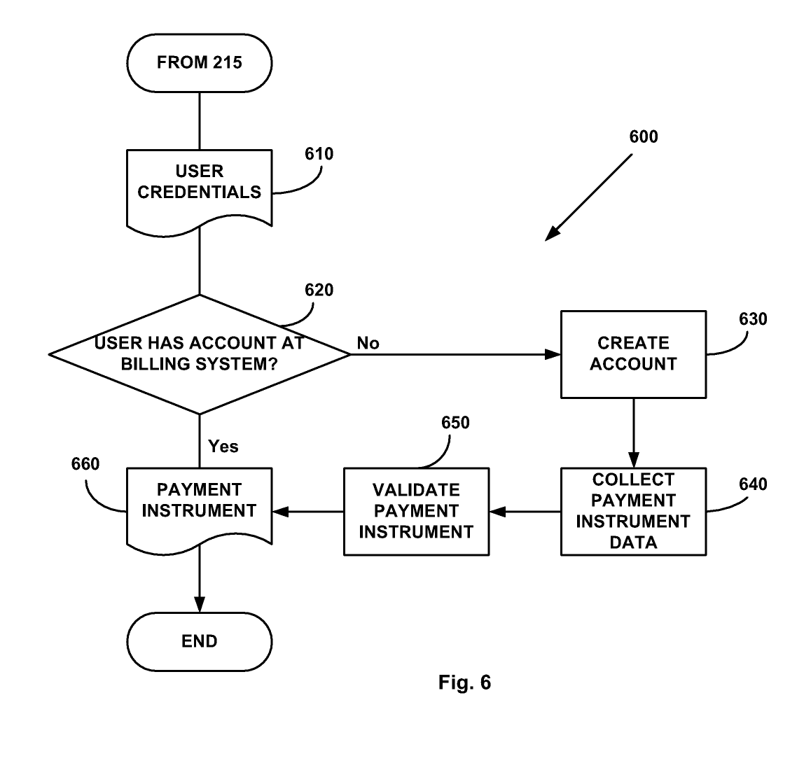

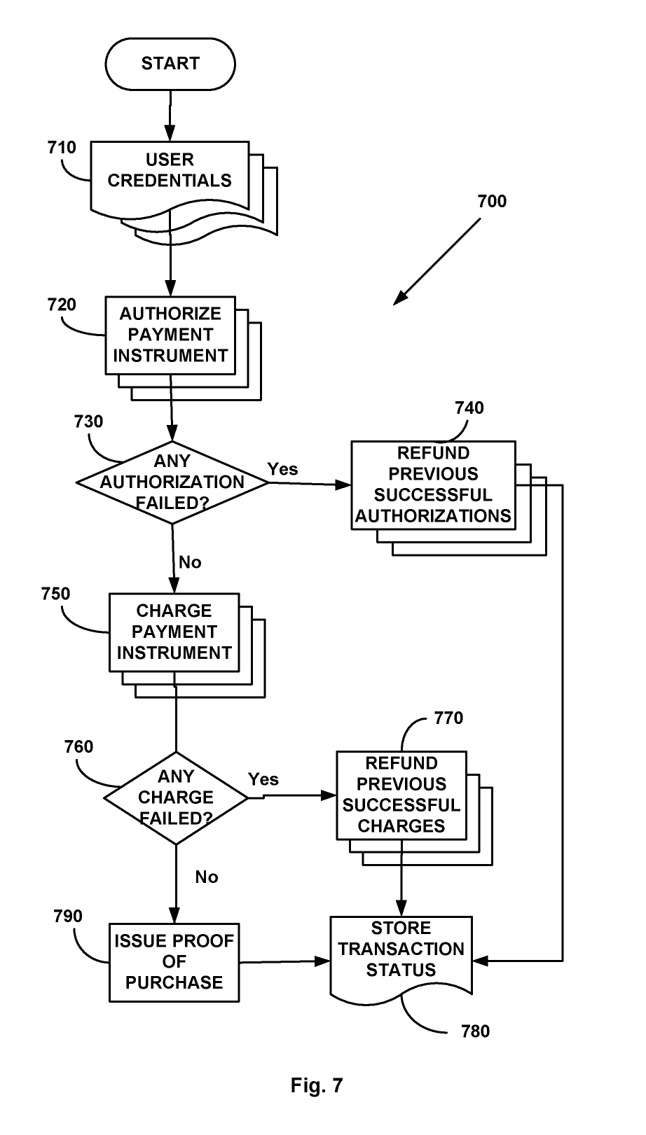

The payment service 215 comprises three parts:
A payment preparations module 216—when a user forms a group or confirms an invitation, the payment preparations module gathers information regarding the user's identity and payment means and transfers the information to the retailer's back office systems (arrow 440). For Payment Card Industry Data Security Standard (PCI-DSS) compliance purposes, the collection of payment instrument data may be delegated to external designated services or, at the retailer's discretion, to its billing system. Regardless of the actual executor, the Payment preparations module oversees the correct and full payment instrument data collection.
Preliminary payment validation module 217, which performs initial validation of the payment instrument supplied by the user, as detailed in conjunction with FIG. 6;
A dynamic payment execution module—before articles can be delivered, the payment execution module transfers payment means debit orders to the retailer's back office systems (arrow 435), along with any other data required by these systems to complete the payment process (e.g. user identification, transforming user's virtual identity to customer number identified by the back office systems, etc.). The process is detailed in FIG. 7.

The progressive pricing engine and the data model that supports it handle the determination of the basic group price. The basic price is the article's price based solely on the group size. For example, a group of 3 members may award its members a 20% reduction compared to a 30% reduction awarded to members of a 5 members group and a maximal reduction of 40% awarded to members of a 6 members group.

The progressive pricing engine also tracks the group members' identities and identifies among them subscribers to the service. Such identified members may not be required to pay for the group purchase, or may receive a special reduction, since the price may be included in their subscription price. The progressive pricing engine associates a price with each group member according to their identities. The identification process involves mapping between the user's subscriber ID and his social networks identities, performed in the user management module.

FIG. 6 is a flowchart 600 showing the payment validation processing done at the ‘retailer's billing system upon invitation acceptance by a user. In step 610 the group payment mechanism 215 sends the user's credentials such as name, email, etc. to the ‘retailer's billing system 500. If the user is identified by the billing system as having an account, his payment instrument (e.g. credit card) which is known to the system is used as the payment instrument 660. Otherwise, if the user is unknown to the system, an account is created for the user 630, the user is prompted to provide his payment instrument data 640, the provided payment instrument is then validated by the system (e.g. vis-a-vis the credit card company) 650 and upon successful validation the payment instrument is used as the actual payment instrument 660. To validate the payment instrument, the group payment mechanism 215 authorizes the user's payment instrument for US$1 in order to minimize the impact on the user's balance at the payment instrument provider.

FIG. 7 is a flowchart 700 showing the processing done at the group formation and payment tracking module 445 upon the completion of a group formation (i.e. the target group size has been reached or the initiator has decided to close the group). In step 710 the user credentials of the group members are communicated to the retailer's billing system 500 for payment authorization, i.e. a pending charge or hold of the full purchase amount on the user's payment account 720. Any failed authorization is refunded 740 along with previous successful authorizations.

If no authorization has failed, the process proceeds to charge the payment instruments for which the payment authorizations have been successful 750. Any failed charge is refunded 770 along with previous successful charges.

If no charges have failed, the process proceeds to issue proof of purchase for the successful charges 790.

In both cases the system stores the final status of the transaction 780.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

1. A system for providing progressive on-line group purchasing of goods and services, comprising:
at least one application server communicating over the interne with a plurality of electronic user devices and communicating with at least one retailer's server;
at least one back-end server communicating with the at least one application server;
each user of said electronic user devices is a member of at least one social network;
each one of said electronic user devices running a client application communicating with the at least one application server;
the application server comprising:
a delivery management module configured to communicate with the retailers' server to enable article selection;
interface to at least one social network, email account or IM service;
a group formation and tracking module;
interface to the at least one retailer's back-office systems; and
a purchasing and payment engine configured to communicate separate purchasing and payment information to said at least one retailer's server and receive from said at least one retailer's server separate proofs of purchase for each one of said group members.

2. The system of claim 1, wherein said client application is configured to:
select goods or services to purchase; and
create a group of predetermined maximal size from among friends in said at least one social network, wherein said group size determines the initial price of said selected goods or services.

3. The system of claim 1, wherein said client application is configured to:
select goods or services to purchase; and
create a group of predetermined minimal size wherein said minimal group size determines the initial price of said selected goods or services.

4. The system of claim 1, wherein said at least one application server comprises a plurality of application servers, the system further comprising a load balancer configured to divide the load from said plurality of electronic user devices between said at plurality of application servers.

5. The system of claim 1, wherein said purchasing and payment engine comprises a flexible pricing process configured to:
provide an initial price and a target group size for said selected article; and
update said initial price as a result of changes in said group size.

6. The system of claim 1, wherein said article is selected from the group consisting of: video, TV programs, movies, games, digital books, music, merchandise, fashion and electronics.

7. A method of providing progressive on-line group purchasing of goods and services, comprising:
selecting goods or services to be purchased;
receiving a target group size and price;
creating a group of said target size from among friends in at least one social network, email contacts and Instant Messaging (IM) contacts;
communicating separate purchasing and payment information to a retailer's server; and
receiving from said retailer's server separate proofs of purchase for each one of said group members.

8. The method of claim 7, further comprising, during said step of creating, updating the price according to a current number of group members.

9. The method of claim 7, further comprising:
checking by said retailer's server whether a received purchasing information is for a registered user; and
creating an account for said user if he is not registered.
